(19) United States
(12) Patent Application Publication
(10) Pub. No.: US 2022/0230352 A1
(43) Pub. Date: Jul. 21, 2022

(54) SYSTEM AND METHODS FOR GRAPHICS RENDERING AND TRACKING

(71) Applicant: Facebook Technologies, LLC, Menlo Park, CA (US)

(72) Inventors: Mahdi Salmani Rahimi, San Francisco, CA (US); Yu Mao, Mountain View, CA (US); Zhiqing Rao, Redmond, WA (US); Charlene Mary Atlas, Redmond, WA (US); Jasmine Soria Sears, Kirkland, CA (US); Ocean Quigley, Oakland, CA (US); Romain Bachy, Seattle, WA (US); Yehezkel Shraga Resheff, Tel Aviv (IL); Michal Rosen, New York, NY (US); Michael Bunnell, Pleasanton, CA (US); Bret Hobbs, Moraga, CA (US)

(21) Appl. No.: 17/592,940

(22) Filed: Feb. 4, 2022

Related U.S. Application Data
(60) Provisional application No. 63/146,465, filed on Feb. 5, 2021.
(60) Provisional application No. 63/155,897, filed on Mar. 3, 2021.
(60) Provisional application No. 63/185,844, filed on May 7, 2021.
(60) Provisional application No. 63/238,740, filed on Aug. 30, 2021.

(51) Int. Cl. G06T 7/73; G06T 19/00; G06T 7/55; G06T 17/20; G06V 40/16; H04L 65/1066

(52) U.S. Cl. CPC G06T 7/73; G06T 19/006; H04L 65/1066; G06T 17/20; G06V 40/168; G06T 7/55

(57) ABSTRACT

One embodiment is directed to controlling a computing system based on an interpreted user intention. Another embodiment is directed to generating a smoothed position of a feature based upon detected and reprojected positions of the feature. Another embodiment is directed to performing one or more image treatments on a facial region of a user until the perceived SQS satisfies the predetermined target SQS. Another embodiment is directed to video conferencing monitoring the quality of video feed coming from the participants of the video conferencing and creating an image or video from the feed when that participant's feed is good and replacing the live video with the newly created good quality image or video when the feed is bad. Another embodiment is directed to a process of baked triplanar projection using triangles generated from a tessellation, where the baked triplanar projection can generate a 2D mesh including UV coordinates.

### PRIORITY

This application claims the benefit under 35 U.S.C. § 119(e) of U.S. Provisional Patent Application No. 63/146,465, filed 5 Feb. 2021, U.S. Provisional Patent Application No. 63/155,897, filed 3 Mar. 2021, U.S. Provisional Patent Application No. 63/185,844, filed 7 May 2021, U.S. Provisional Patent Application No. 63/238,740, filed 30 Aug. 2021, which are incorporated herein by reference.

### TECHNICAL FIELD

This disclosure generally relates to artificial-reality systems.

### BRIEF DESCRIPTION OF THE DRAWINGS

FIG. 1A illustrates an example artificial reality system.

FIG. 1B illustrates an example augmented reality system.

FIG. 2 illustrates an example of a scene viewed through the artificial reality system and the application of smoothing the location of an identified feature.

FIG. 3 illustrates an example method for smoothing the location of an identified feature across frames using motion compensation.

FIG. 4 illustrates a cross-section of an example head-mounted display.

FIG. 5 illustrates an isometric view of an example near-eye display system.

FIGS. 6A and 6B illustrate one or more identified challenges in artificial reality headsets and/or glasses that use additive light.

FIGS. 6C-6E illustrate systems and examples for inclusive rendering of various human facial tone.

FIG. 7 illustrates a flow diagram of a method for inclusive rendering of various human facial tones.

FIG. 8 illustrates an example method for monitoring video feed, preparing an image to be used in case of a freeze, and filtering another image on top of the prepared image to indicate that an individual's video feed has frozen and for how long.

FIG. 9 illustrates an example network in which various embodiments may be practiced.

FIG. 10 illustrates an example process of baked triplanar projection.

FIG. 11 illustrates an example process of splitting triangles.

FIG. 12 illustrates an example network environment associated with a virtual reality system.

FIG. 13 illustrates an example computer system.

### DESCRIPTION OF EXAMPLE EMBODIMENTS

### Camera Motion Compensation for Detection Smoothing

Currently, AR/VR devices face multiple challenges, such as tracking objects within the user's environment. For each frame, an object's location in the image space is determined. However, due to the user's head movement and imperfections in the tracking algorithm, the tracking results could stutter or be jittery. One way to solve the jitter issue is by smoothing the tracking results across frames. However, when the user's head movement is significant, this smoothing technique would introduce lag. Particular embodiments disclosed in the present disclosure address the frame-to-frame jitter of tracked objects caused by the user's head movement without introducing lag or relying on more complex image analysis.

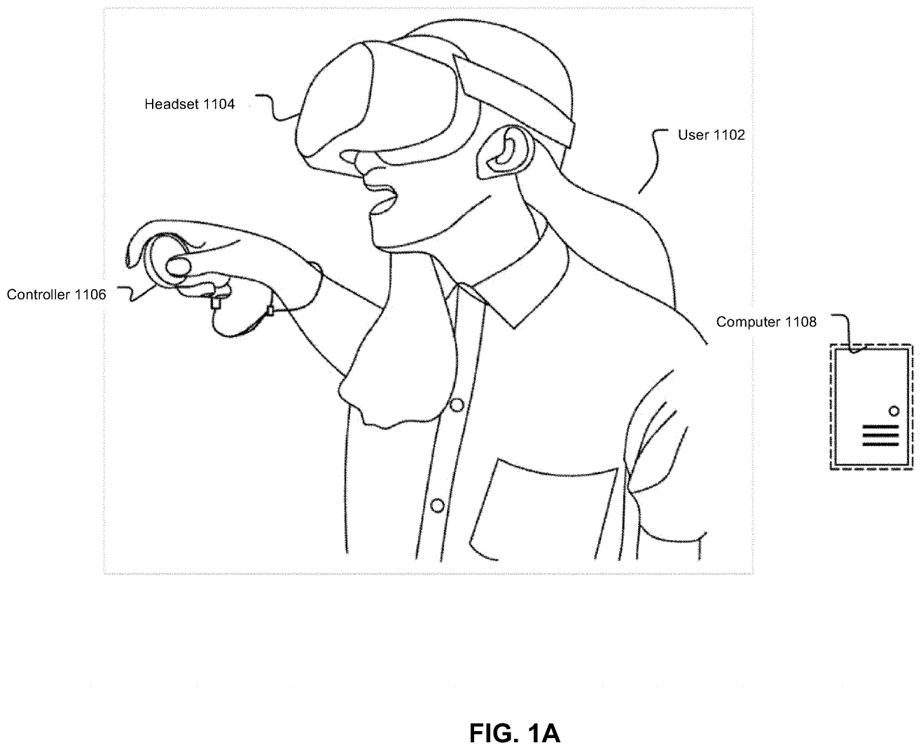

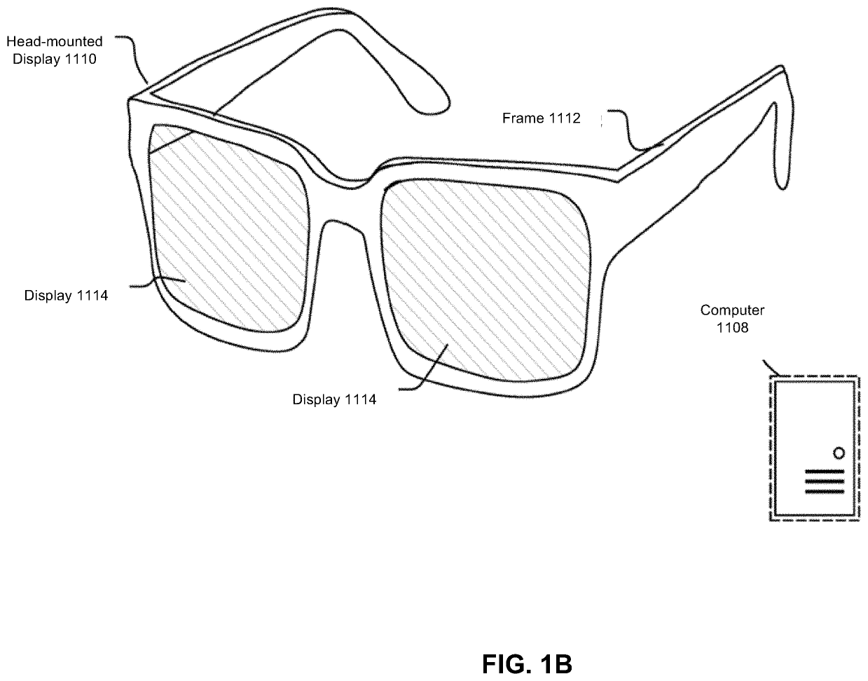

FIG. 1A illustrates an example artificial reality system 1100A. In particular embodiments, the artificial reality system 1100A may be configured to perform one or more processes as described herein. In particular embodiments, the artificial reality system 1100A may comprise a headset 1104, a controller 1106, and a computing system 1108. A user 1102 may wear the headset 1104 that may display visual artificial reality content to the user 1102. The headset 1104 may include an audio device that may provide audio artificial reality content to the user 1102. The headset 1104 may include one or more cameras which can capture images and videos of environments. The headset 1104 may include an eye tracking system to determine the vergence distance of the user 1102. The headset 1104 may include a microphone to capture voice input from the user 1102. The headset 1104 may be referred as a head-mounted display (HDM). The controller 1106 may comprise a trackpad and one or more buttons. The controller 1106 may receive inputs from the user 1102 and relay the inputs to the computing device 1108. The controller 1106 may also provide haptic feedback to the user 1102. The computing device 1108 may be connected to the headset 1104 and the controller 1106 through cables or wireless connections. The computing device 1108 may control the headset 1104 and the controller 1106 to provide the artificial reality content to and receive inputs from the user 1102. The computing device 1108 may be a standalone host computing device, an on-board computing device integrated with the headset 1104, a mobile device, or any other hardware platform capable of providing artificial reality content to and receiving inputs from the user 1102.

FIG. 1B illustrates an example augmented reality system 1100B. In particular embodiments, the augmented reality system 1100B can perform one or more processes as described herein. The augmented reality system 1100B may include a head-mounted display (HMD) 1110 (e.g., glasses) comprising a frame 1112, one or more displays 1114, and a computing device 1108. The displays 1114 may be transparent or translucent allowing a user wearing the HMD 1110 to look through the displays 1114 to see the real world and displaying visual artificial reality content to the user at the same time. The HMD 1110 may include an audio device that may provide audio artificial reality content to users. The HMD 1110 may include one or more cameras which can capture images and videos of environments. The HMD 1110 may include an eye tracking system to track the vergence movement of the user wearing the HMD 1110. The HMD 1110 may include a microphone to capture voice input from the user. The augmented reality system 1100B may further include a controller comprising a trackpad and one or more buttons. The controller may receive inputs from users and relay the inputs to the computing device 1108. The controller may also provide haptic feedback to users. The computing device 1108 may be connected to the HMD 1110 and the controller through cables or wireless connections. The computing device 1108 may control the HMD 1110 and the controller to provide the augmented reality content to and receive inputs from users. The computing device 1108 may be a standalone host computer device, an on-board computer device integrated with the HMD 1110, a mobile device, or any other hardware platform capable of providing artificial reality content to and receiving inputs from users.

Object tracking within the image domain is a known technique. For example, a stationary camera may capture a video of a moving object, and a computing system may compute, for each frame, the 3D position of an object of interest or one of its observable features relative to the camera. When the camera is stationary, any change in the object's position is attributable only to the object's movement and/or jitter caused by the tracking algorithm. In this case, the motion of the tracked object could be temporally smoothed by simply applying a suitable averaging algorithm (e.g., averaging with an exponential temporal decay) to the current estimated position of the object and the previously estimated position(s) of the object.

Motion smoothing becomes much more complex in the context of artificial reality. For artificial reality systems (e.g., the systems 1100A and 1100B), an external-facing camera is often mounted on the HMD and, therefore, could be capturing a video of another moving object while moving with the user's head. When using such a non-stationary camera to track a moving object, the tracked positional changes of the object could be due to not only the object's movements but also the camera's movements. Therefore, the aforementioned method for temporally smoothing the tracked positions of the object would no longer work.

Embodiments described herein are directed to a new technique for temporally smoothing the tracked positions of an object captured using a non-stationary camera. This new technique may be applied in a variety of scenarios, regardless of whether the tracked object and/or the camera is moving or not (e.g., the camera could be mounted on an HMD). At a high-level, a computing system implementing this technique would factor out the camera's movements by reprojecting the object's 3D position at time t−1, which is estimated based on an image captured from the camera's viewpoint at that instant, onto the image space of the camera having a potentially different viewpoint at time t. As known in the art, the viewpoint or pose of the camera at any instant may be determined using localization techniques, such as SLAM or visual-inertial odometry. Also known in the art are techniques for estimating the depth of an object (e.g., stereo depth estimation, depth sensors, etc.). The computing system may use these known techniques to determine the camera's viewpoint in 3D space at time t−1 and the 3D position of the object at that time relative to the camera. At time t, the computing system may determine the current viewpoint of the camera in 3D space and then project the 3D position of the object at time t−1 onto the image space of the camera at its current viewpoint. This reprojection of the object allows the computing system to determine where the object should have appeared in the image space of the camera had the camera taken an image of the object at time t−1 from the camera's current viewpoint (i.e., the camera's viewpoint at time t). The reprojected screen-space position of the object from time t−1 and the screen-space position of the current object at time t would both be defined with respect to the camera's current viewpoint, similar to the aforementioned scenario where the camera is stationary. Thus, the motion of the object could again be smoothed using any suitable smoothing algorithm. For example, the smoothed screen-space position of the object at time t could be approximated by a weighted average of the detected screen-space position of the object at time t and the reprojected screen-space position of the object from time t−1. In particular embodiments, the smoothing algorithm could factor in the reprojected screen-space positions of the object from multiple pervious times, such as t−1, t−2, . . . , t−n.

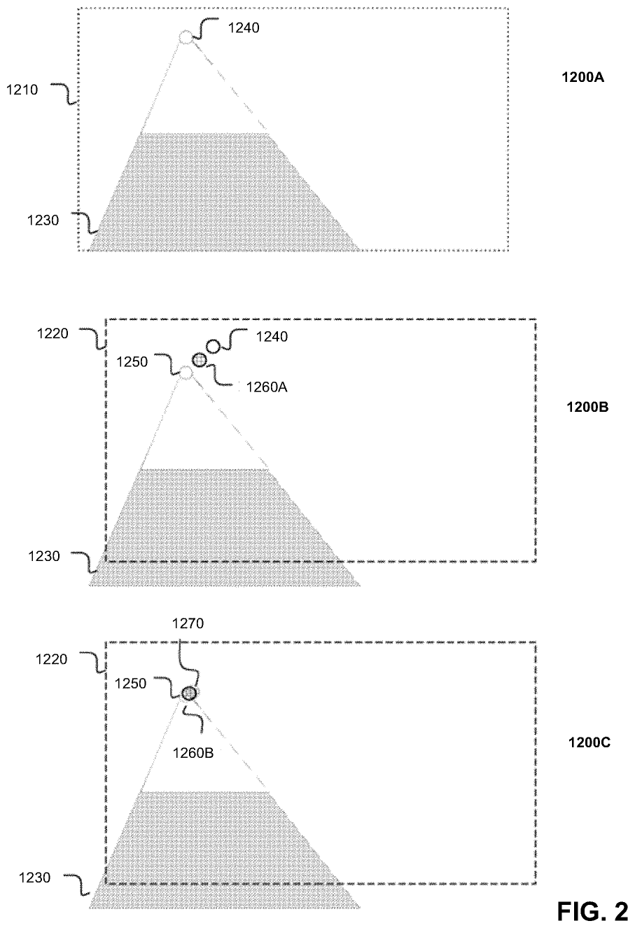

FIG. 2 illustrates an example of a scene 1200A acquired through the camera(s) of an artificial reality system at time t−1. For example, the location of an identified feature, point 1240, may be associated with any real-world object, such as the tip of a snow-covered mountain 1230 in the scene. The identifying feature may be of any object, animate or inanimate, which is sufficiently identifiable to be incorporated within the map of the artificial reality. At time t−1, the camera captures the frame 1210. Point 1240 indicates the screen-space position of the tracked object within frame 1210 at time t−1.

Scene 1200B illustrates an example of the same scene using a simple method to smooth the position of the tip of the mountain 1230 using the prior perceived location, prior point 1240, of the identifying feature at time t−1 and the current perceived location, current point 1250, of the identifying feature at time t. An averaging function produces a smoothed location, smoothed point 1260A, which approximates the location of the identifying point. However, when the camera's position changes significantly, the smoothed location of the identified feature (e.g., the tip of the mountain 1230) may differ substantially from the location of the identified point 1250 in the frame. The error is compounded when the camera's displacement is large for a sustained period of time. For example, if an augmented reality object is placed and displayed in relation to such an identified feature, the object may appear to be updated slowly, i.e. with lag; jiggle or jitter in the display; or appear in another manner that inhibits the user experience, e.g., an object floating in the air.

Scene 1200C illustrates an example application of an embodiment of the present disclosure on the same scene. Here, the smoothing is carried out on the current perceived location, current point 1250, of the identifying feature at time t and reprojected point 1270. Projected point 1270 is the reprojected location of the prior perceived location, prior point 1240, based on the estimated camera viewpoints calculated from sensor input that estimates the user's movement between the frames 1210 and 1220 and the estimated depth of the tip of the mountain 1230. The resulting smoothed location is smoothed point 1260B.

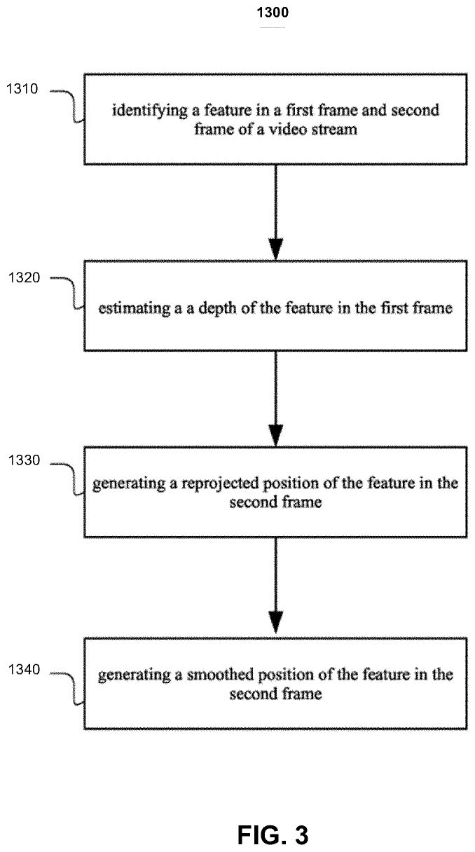

FIG. 3 illustrates an example method 1300 for smoothing the location of an identified feature across frames using motion compensation. The method may begin at step 1310, where the computing device 1108 may identify an identical feature in a first frame and second frame of a video stream captured by a camera. The frames may be acquired at different points of time and from different viewpoints of a user. At step 1320, the computing device 1108 may estimate a depth of the feature in the first frame at time t relative to the first viewpoint of the camera. At step 1330, the computing device 1108 may generate a reprojected position of the feature at time t−1. The reprojected position may be based upon the depth of the feature at the first time, the first viewpoint of the camera at the first time, and the second viewpoint of the camera at the second time. At step 1340, the computing device 1108 may generate a smoothed position of the identified feature based upon its detected position in the second frame and the reprojected position of the identified feature.

In particular embodiments, the computing device 1108 may calculate the delta between the two frames at step 1320 from the differential vector between the respective poses of the user at frame t and frame t−1. The computing device 1108 may use motion data or position data received from the HMD 1110 which may incorporate sensors such as GPS, infrared sensors, ultrasonic sensors, LIDAR, accelerometers, or gyroscopes. Although this disclosure describes computing the differential vector from motion data, this disclosure contemplates computing the differential vector in any suitable manner.

In particular embodiments, the computing device 1108 may carry out the smoothing of the location at step 1340 with a simple weighted average. In other embodiments, a more advanced adaptive filtering function may be used such as an integrated autoregressive filter or moving average filter.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for smoothing the location of an identified feature across frames using motion compensation including the particular steps of the method of FIG. 3, this disclosure contemplates any suitable method for smoothing the location of an identified feature across frames using motion compensation including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

Inclusive Rendering for People in Headset with Additive Display

Artificial reality headsets, glasses, and/or other devices use additive light display technology to make virtual light and real world light overlap. This allows users to see virtual content in their real world. However, since black is the absence of light, when you attempt to display black on an additive light display, it appears transparent. As an extension, dark content is very hard to see due to the limited amount of light that is displayed. This has serious consequences for rendering humans with different facial tones and/or gender presentations that have different color brightness.

Accordingly, the present embodiments include a subjective quality score (SQS) formula of the human visibility in additive display and artistic treatments are selected based on targeting SQS, which may be then injected, for example, into a volumetric video call or other AR-based videoconference to improve the visibility. For example, a method may include detecting the face region in an AR calling receiver side before the rendering. The method may further include calculating a median skin tone brightness by subsampling pixels in the face region. The method may further include calculating the receiver side display and background luminance. The method may further include deriving the perceived SQS from median facial tone brightness and display and/or background luminance. The method may further include evaluating the SQS gap between a target SQS and a perceived SQS. In response to determining that the target SQS is not satisfied, the method may further include determining the most optimal artistic treatments such that the target SQS may be satisfied. The method may then include injecting the selected artistic treatments (e.g., color correction, re-lighting, adding outline, sharpening, relighting, and so forth), into, for example, a volumetric video call or other AR-based videoconference rendering pipeline to improve the visibility. The method may then conclude with performing an SQS calculation on the rendered frame and feedback to adjust the artistic treatment intensity. In this way, users (e.g., on the sender side) with darker facial tones or complexions and/or when the AR device is used in an environment with brighter backgrounds (e.g., on the receiver side), the receiver side user may enable (or automatically enabled) inclusive rendering support to achieve enough visibility to perceive the sender user more clearly.

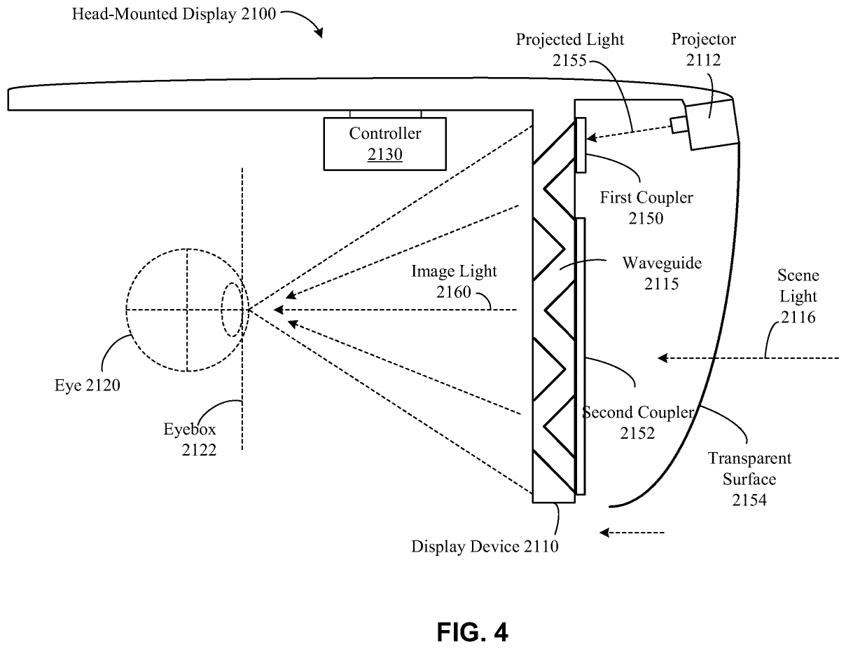

FIG. 4 illustrates a cross-section of an example head-mounted display (HMD)/glasses 2100. The HMD includes an example wearable display device 2110, which may include at least one waveguide 2115. It should be appreciated that the HMD/glasses 2100 as illustrated is an example of one embodiment of an HMD that may be useful in providing adaptive rending, in accordance with the presently disclosed embodiments. In another embodiment, the HMD/glasses 2100 may include a see-through HMD which may not include a waveguide and may instead render images directly onto, for example, one or more transparent or semi-transparent mirrors that may be placed in front of the eyes of a user, for example. FIG. 4 also shows an eyebox 2122, which is a location where a user's eye 2120 may be positioned when the user wears the display device 2110. As long as the eye 2120 is aligned with the eyebox 2122, the user may be able to see a full-color image, or a pupil replication directed toward the eyebox 2122 by the waveguide 2115. The waveguide 2115 may produce and direct many pupil replications to the eyebox 2122. The waveguide 2115 may be configured to direct image light 2160 to the eyebox 2122 located proximate to the eye 2120. For purposes of illustration, FIG. 4 shows the cross-section associated with a single eye 2120 and single waveguide 2115. In certain embodiments, the waveguide 2115 or another waveguide may provide image light to an eyebox located at another eye of the user.

The waveguide 2115 may be composed of one or more materials (e.g., plastic, glass, etc.) with one or more refractive indices that effectively minimize the weight and widen a field of view (FOV) of the display device 2110. In alternate configurations, the display device 2110 may include one or more optical elements between the waveguide 2115 and the eye 2120. The optical elements may act to, for example, correct aberrations in the image light 2160, magnify the image light 2160, make some other optical adjustment of the image light 2160, or perform a combination thereof. Examples of optical elements may include an aperture, a Fresnel lens, a refractive (e.g., convex and/or concave) lens, a reflective surface, a filter, or any other suitable optical element that affects image light. The waveguide 2115 may include a waveguide with one or more sets of Bragg gratings, for example.

One form of display that may be used in an HMD/glasses 2100 may be referred to as a scanline or one-dimensional (“1D”) waveguide display. In this display, a row of a light source may generate the light that is used to illuminate the entire vertical space (or horizontal space, where appropriate) of the display. Multiple smaller images may be combined to form a larger composite image as perceived by the viewer. A scanning element may cause the source light, treated by waveguide components, to be output to the eye 2120 of the user in a specific pattern corresponding to a generation pattern used by the emitters to optimize display draw rate. For example, the light source may first be provided color values corresponding to a single row of pixels along the top of a display image. The light may be transferred to the appropriate section of the eyebox 2122 using a waveguide-based process assisted with a microelectromechanical system (MEMS)-powered oscillating mirror. After a short period of time, the light source may be provided color values corresponding to the next row of pixels (e.g., below the first). The light for this section of the image may then use the same process to position the color values in the appropriate position. Scanning displays may utilize less power to run and may generate less heat than traditional displays comprised of the same emitters. Scanning displays may have less weight as well, owing in part to the quality of the materials used in the scanning element and optics system. The frame rate of the display may be limited based on the oscillation speed of the mirror.

Another form of display that may be used in an HMD/glasses 2100 may be a 2D or two-dimensional waveguide display. In such a display, no oscillating mirror is utilized, as a light source may be used that comprises vertical and horizontal components (e.g., in an array). Where the 1D variant lights the display on a row-by-row basis, the 2D variant may be capable of providing a significantly improved frame rate because the 2D variant may not dependent on the oscillating mirror to provide for the vertical component of an image. To further improve the frame rate, the light source of a 2D waveguide display may be bonded to the controller and/or memory providing driving instructions for the display system. For example, the light source may be bonded to the memory that holds the color instructions for the display and/or the driver transistors. The result of such a configuration is that the light source for such a display may be operable with a considerably faster frame rate.

In certain embodiments, an HMD/glasses 2100 may comprise a light source such as a projector 2112 that emits projected light 2155 depicting one or more images. Many suitable display light source technologies are contemplated, including, but not limited to, liquid crystal display (LCD), liquid crystal on silicon (LCOS), light-emitting diode (LED), organic LED (OLED), micro-LED (μLED), digital micromirror device (DMD), any other suitable display technology, or any combination thereof. The projected light 2155 may be received by a first coupler 2150 of the waveguide 2115. The waveguide 2115 may combine the projected light 2155 with real-world scene light 2116 received by a second coupler 2152. The scene light 2116 may be, for example, light from a real-world environment, and may pass through a transparent (or semi-transparent) surface 2154 to the second coupler 2152. The transparent surface 2154 may be, for example, a protective curved glass or a lens formed from glass, plastic, or other transparent material. The coupling components of the waveguide 2115 may direct the projected light 2155 along a total internal reflection path of the waveguide 2115. The scene light 2116 may be seen by the user's eye 2120.

Furthermore, the projected light 2155 may first pass through a small air gap between the projector 2112 and the waveguide 2115 before interacting with a coupling element incorporated into the waveguide (such as the first coupler 2150). The light path, in some examples, may include grating structures or other types of light decoupling structures that decouple portions of the light from the total internal reflection path to direct multiple instances of an image, “pupil replications,” out of the waveguide 2115 at different places and toward the eyebox 2122 of the HMD/glasses 2100.

In certain embodiments, one or more controllers 2130 may control the operations of the projector 2112. The controller 2130 may generate display instructions for a display system of the projector 2112. The display instructions may include instructions to project or emit one or more images. In certain embodiments, display instructions may include frame image color data. The display instructions may be received from, for example, a processing device included in the HMD/glasses 2100 of FIG. 4 or in wireless or wired communication therewith. The display instructions may further include instructions for moving the projector 2112 or for moving the waveguide 2115 by activating an actuation system. The controller 2130 may include a combination of hardware, software, and/or firmware not explicitly shown herein so as not to obscure other aspects of the disclosure.

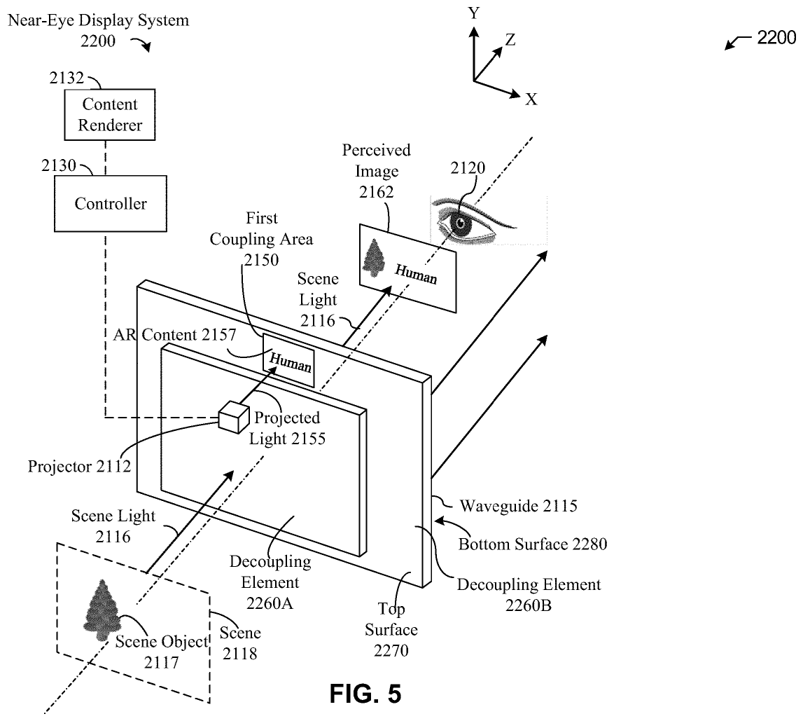

FIG. 5 illustrates an example isometric view of a near-eye display system (NED) 2200. In certain embodiments, the NED 2200 may be a component of the HMD/glasses 2100. The NED 2200 may include at least one projector 2112, a waveguide 2115, and a controller 2130. A content renderer 2132 may generate representations of content, referred to herein as AR virtual content 2157, to be projected as projected light 2155 by the projector 2112. The content renderer 2132 may send the representations of the content to the controller 2130, which may in turn generate display instructions based on the content and send the display instructions to the projector 2112.

For purposes of illustration, FIG. 5 shows the NED 2200 associated with a single eye 2120, but in other embodiments another projector 2112, waveguide 2115, or controller 2130 that is completely separate or partially separate from the NED 2200 may provide image light to another eye of the user. In a partially separate system, one or more components may be shared between the waveguides for each eye. In one embodiment, a single waveguide 2115 may provide image light to both eyes of the user. Also, in some examples, the waveguide 2115 may be one of multiple waveguides of the NED 2200. In another embodiment, in which the HMD includes a see-through HMD, the image light may be provided onto, for example, one or more transparent or semi-transparent mirrors that may be placed in front of the eyes of the user.

In certain embodiments, the projector 2112 may include one or more optical sources, an optics system, and/or circuitry. The projector 2112 may generate and project the projected light 2155, including at least one two-dimensional image of AR virtual content 2157, to a first coupling area 2150 located on a top surface 2270 of the waveguide 2115. The image light 2155 may propagate along a dimension or axis toward the coupling area 2150, for example, as described above with reference to FIG. 4. The projector 2112 may comprise one or more array light sources. The techniques and architectures described herein may be applicable to many suitable types of displays, including but not limited to liquid crystal display (LCD), liquid crystal on silicon (LCOS), light-emitting diode (LED), organic LED (OLED), micro-LED (μLED), or digital micromirror device (DMD).

In certain embodiments, the waveguide 2115 may be an optical waveguide that outputs two-dimensional perceived images 2162 in the scene light 2116 (e.g., with respect to a scene object 2117 and scene 2118) directed to the eye 2120 of a user. The waveguide 2115 may receive the projected light 2155 at the first coupling area 2150, which may include one or more coupling elements located on the top surface 2270 and/or within the body of the waveguide 2115 and may guide the projected light 2155 to a propagation area of the waveguide 2115. A coupling element of the coupling area 2150 may be, for example, a diffraction grating, a holographic grating, one or more cascaded reflectors, one or more prismatic surface elements, an array of holographic reflectors, a metamaterial surface, or a combination thereof. In particular configurations, each of the coupling elements in the coupling area 2150 may have substantially the same area along the X-axis and the Y-axis dimensions, and may be separated by a distance along the Z-axis (e.g., on the top surface 2270 and the bottom surface 2280, or both on the top surface 2270 but separated by an interfacial layer (not shown), or on the bottom surface 2280 and separated with an interfacial layer or both embedded into the body of the waveguide 2115 but separated with the interfacial layer). The coupling area 2150 may be understood as extending from the top surface 2270 to the bottom surface 2280. The coupling area 2150 may redirect received projected light 2155, according to a first grating vector, into a propagation area of the waveguide 2115 formed in the body of the waveguide 2115 between decoupling elements 2260A, 2260B.

A decoupling element 2260A may redirect the totally internally reflected projected light 2155 from the waveguide 2115 such that the light 2155 may be decoupled through a decoupling element 2260B. The decoupling element 2260A may be part of, affixed to, or formed in, the top surface 2270 of the waveguide 2115. The decoupling element 2260B may be part of, affixed to, or formed in, the bottom surface 2280 of the waveguide 2115, such that the decoupling element 2260A is opposed to the decoupling element 2260B with a propagation area extending therebetween. The decoupling elements 2260A and 2260B may be, for example, a diffraction grating, a holographic grating, an array of holographic reflectors, etc., and together may form a decoupling area. In certain embodiments, each of the decoupling elements 2260A and 2260B may have substantially the same area along the X-axis and the Y-axis dimensions and may be separated by a distance along the Z-axis.

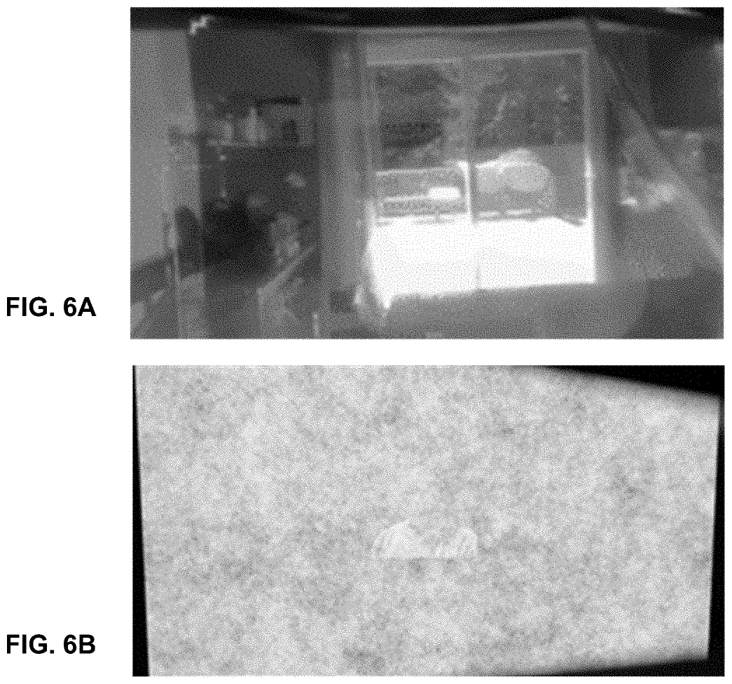

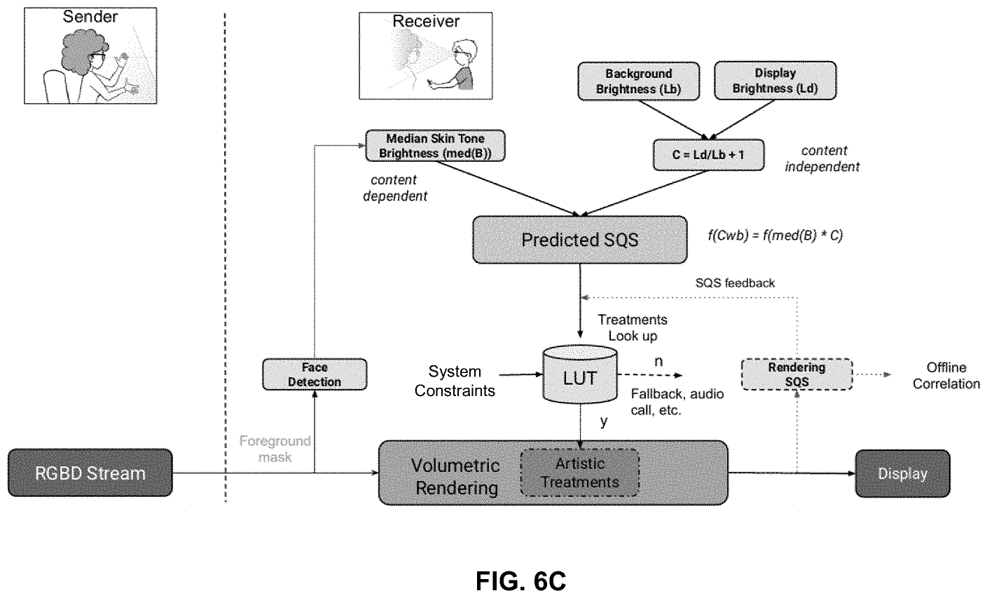

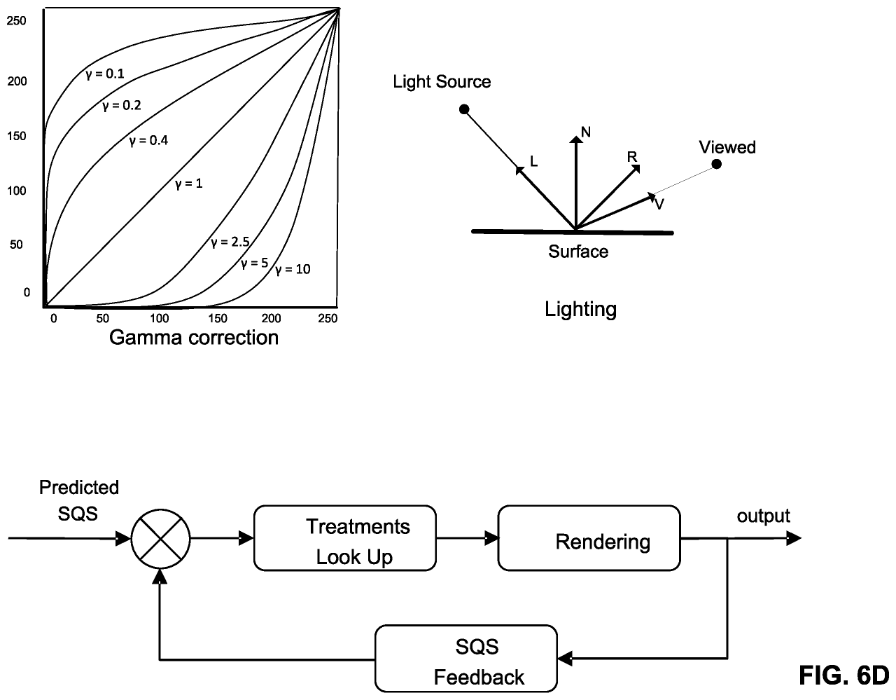

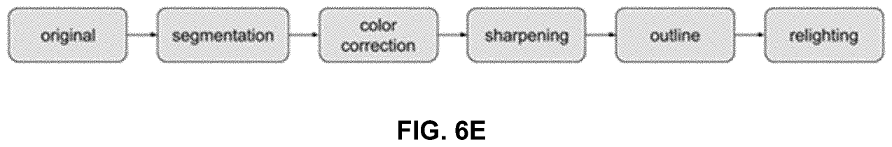

FIGS. 6A and 6B illustrate one or more identified challenges in artificial reality headsets and/or glasses that use additive light technology to make virtual light and real world light overlap. This allows users to see virtual content in their real world. However, since black is the absence of light, when you attempt to display black on an additive light display, it appears transparent. As an extension, dark content is very hard to see due to the limited amount of light that is displayed. This may lead to an imbalance of how users with varying skin tones are inequitably rendered. In certain embodiments, the primary factor of content visibility is the contrast between the brightness of the content and the luminance of the environment. Insufficient contrast may also result in poor visual results. A secondary factor is the color matching conflicts between the content and background. Cluttered backgrounds may also, in some embodiments, exacerbate poor content visibility. In certain embodiments, a user with a lighter facial tone and a user with a darker facial tone may be rendered at varying contrasts. For example, in one embodiment, an experimental analysis yielded that the SQS score for the user with lighter facial tones were higher than the scores for the user with the darker facial tones. The experimental analysis further yielded that a 40:1 additive contrast may be utilized to cause the user with the darker facial tones to achieve a maximum subjective quality score of 60%.

FIGS. 6C-6E illustrate systems and examples for inclusive rendering of various human facial tones, in accordance with presently disclosed techniques. The present embodiments describe the inclusive rendering system pipeline, performance and power analysis, and the trade-off between image quality and performance and power. In certain embodiments, as illustrated by FIG. 6C, the system workflow may include detecting the face region of interest (ROI) on the receiver user side. The workflow may further include calculating the median skin tone brightness and calculating the receiver user side display and background luminance. The workflow may then include determining the perceived SQS based on f(Cw) and calculating the SQS gap between predetermined target SQS and the perceived SQS. In response to determining that the perceived SQS predetermined fails to satisfy the target SQS, the workflow may include looking up the most optimal artistic treatments (e.g., from a prestored look-up table (LUT)) suitable for satisfying the predetermined target SQS and injecting the selected artistic treatments into a volumetric rendering pipeline. An alpha mask may also be used to improve the performance and power in, for example, volumetric video calling, artistic rendering, or other AR-based videoconferencing. The workflow may then include performing an SQS calculation on the rendered frame and feedback to adjust the treatment intensity.

For example, as further illustrated by the examples of FIGS. 6C and 6D, for volumetric video calling or other AR-based videoconferencing, the skin tone information may be utilized to predict the perceived SQS. In some embodiments, the skin tone information may be approximated by sampling the points in the face region. In certain embodiments, landmarks may be used on the nose to calculate the mean (e.g., or median) brightness that represents the skin tone. In certain embodiments, sampling 200-300 points in the face elliptical region (e.g., bound by the face box) may include the same median brightness as sampling from the whole face region. In certain embodiments, face tracker machine learning models may be deployed since they are lightweight, well optimized, and may run real-time on mobile devices. For example, face tracker machine learning models may downsample the image frame to some low resolution like 256×256 and calculate the landmarks' position and scale back. As skin tone detection may be run at low frames per second (FPS) and may be applied only for incoming frames, the power and latency impact may be minimal.

For segment mask generation, in certain embodiments, a segmentation mask may be used to mask out the foreground, which may reduce both the video stream bandwidth as well as the GPU workload, including artistic shaders. In certain embodiments, on the sender user side, the system may utilize one or more machine learning models to generate the binary alpha mask per-pixel and combine the bit into RGB video stream captured by the camera. Then the frames are encoded by a video encoder and sent to the receiver user side. On the receiver user side, a mobile GPU may decode the alpha mask bit from one of the RGB color channels.

For display and background luminance detection, in certain embodiments, the system may derive the background nits from sensors-captured pixels with resolution very likely ranging from 100×100 to 300×300. For example, the algorithm may translate pixels into background nits value.

For perceived contrast calculation, in certain embodiments, the perceived contrast is based on the display contrast and the median skin tone brightness. For a set display luminance and environment lighting condition, the display contrast is content independent while the median skin tone brightness is content (caller skin tone) dependent. The perceived contrast may be calculated (as shown below) and may be used as part of the derivation of the SQS.

Display contrast: C=L_{d}/L_{b}+1, where L_{d} is display luminance, L_{b} is background luminance

Perceived contrast calculation: C_{w}=(med(B)*L_{d})/L_{b}+1

In certain embodiments, for SQS calculation, the SQS may be determined and utilized to represent how well the virtual object may be visually perceived through the AR display. For example, a process for calculating SQS includes: SQS may be defined as a unique function α[f(C_{w})] with: C_{w}=(med(B)*L_{d})/L_{b}+1; where C_{w}=perceived contrast; Med(B)=median skin tone luminance; C=L_{d}/L_{b}+1=display contrast; L_{d}=display luminance; L_{b}=background luminance; f(C_{w})=a*C_{w}^{b}+c (a, b, and c are fit parameters); and α=higher level visual process function. In certain embodiments, there are possible ways to improve SQS: Higher display luminance L_{d}; Dimmer background luminance L_{b}; Artistic rendering to increase median skin tone luminance med(B) or to modify skin tone appearance. As discussed above, if the perceived SQS fails to reach the target SQS, the artistic rendering will be applied to improve SQS. Thus, the steps for med(B) and SQS calculation may include determining the ROI pixels, which either face pixels or landmarks on the nose and may be retrieved through ML face tracker, as described above with respect to the “skin tone calculation”. If the input RGB is in RGB space, the input RGB may be converted to linear first and then converted to XYZ color space. The computation of X and Z may, in some instances, be skipped as they may or may not be used for calculation of median(B). For Y to L transformation: If Y<0.008856, L=Y/Yn*903.3; If Y>=0.008856, L=116*(Y/Yn) \hat{ }(⅓)−16; and Assume Las the luminance, and calculate the median(B). The perceived SQS may be then calculated as: SQS=f(x)=a*x^{b}+c.

In certain embodiments, for artistic treatments, referring to FIG. 6E, the objective of inclusive rendering is to increase the visibility while keeping the appearance the same or similar as possible. The luminance and contrast improvements are important factors. For example, the process for artistic treatments may include segmentation, color correction, sharpening, outlining, and relighting. For example, in segmentation, the sender user side may provide the alpha mask texture for the portrait of the user. When rendering the frame, alpha texture would be read and its value will be used as alpha testing to discard pixels outside of the portrait. In color correction, a per-pixel gamma correction and saturation compensation are used to improve the pixel visibility. In sharpening, one or more high pass filters may be used to improve the contrast of the image. In outlining, a Sobel edge detector may be used to detect the contour line, for users to see the sending user more easily. Lastly, in relighting, different lights, like constant warm and color lights, may be added to relighting the face. If there is a depth map, depth values may also be used to calculate the pixel's normal value to get more realistic lighting.

In certain embodiments, for artistic treatment selection based on SQS improvement, SQS may be understood to include any subjective quality score that may be used to evaluate how well objects are perceived. Based on the SQS formula as set forth above, the system may calculate the median luminance at a contrast utilized to reach the target SQS. Additionally, the median luminance improvement of each treatment for different skin tones may be anticipatable, and thus a prestored LUT may be utilized at run-time to search and select the treatments needed to apply based on the SQS. In certain embodiments, for SQS feedback, the visibility improvement for artistic treatments may or may not be deterministic, as relighting view angle, light direction, and normal may all change. For example, referring again to FIG. 6D, the GPU rendered frame may be taken as input, and the system may perform face detection, skin tone and SQS calculation again. If the actual SQS is less than the predicted SQS, then the system may increase the intensity of artistic treatments. If the actual SQS is greater than the predicted SQS, then the system may decrease the intensity of artistic treatments. In certain embodiments, since the face region is known in the input frame, it might be possible to derive the face region in the rendered frame based on some transformations, potentially to skip the face detection. For example, a GPU shader may be utilized to subsample the render-target face region for median face skin tone calculation without making the render target accessible to the CPU.

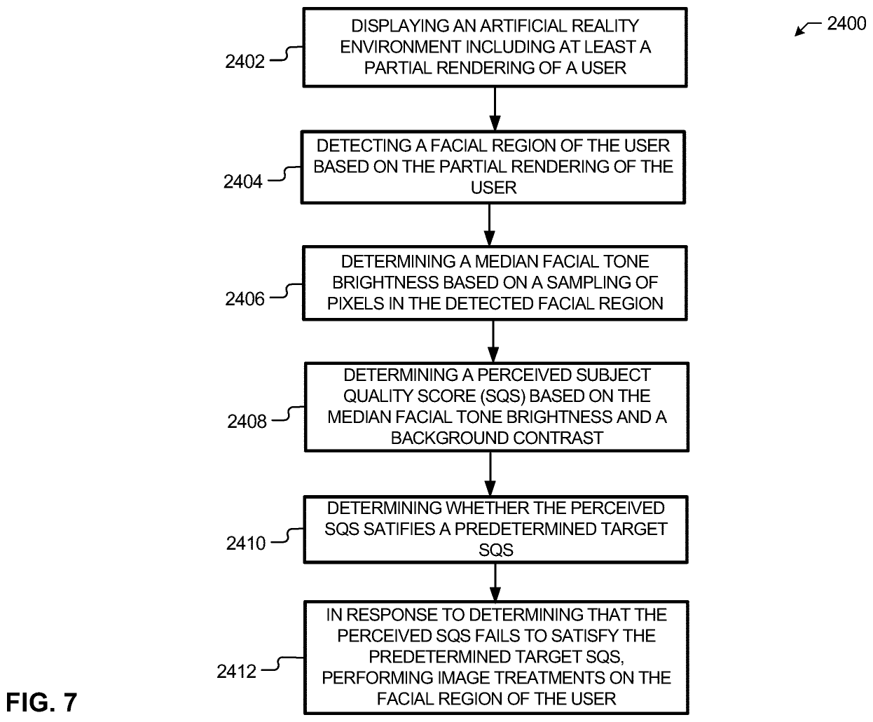

FIG. 7 illustrates a flow diagram of a method 2400 for inclusive rendering of various human facial tones, in accordance with presently disclosed techniques. The method 2400 may be performed utilizing one or more processing devices (e.g., computing platform 2104) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 2400 may begin at block 2402 with one or more processing devices (e.g., computing platform 2104) displaying an artificial reality environment including at least a partial rendering of a user. The method 2400 may then continue at block 2404 with the one or more processing devices (e.g., computing platform 2104) detecting a facial region of the user based on the partial rendering of the user. The method 2400 may then continue at block 2406 with the one or more processing devices (e.g., computing platform 2104) determining a median facial tone brightness based on a sampling of pixels in the detected facial region. The method 2400 may then continue at block 2408 with the one or more processing devices (e.g., computing platform 2104) determining a perceived subjective quality score (SQS) based on the median facial tone brightness and a background luminance. The method 2400 may then continue at block 2410 with the one or more processing devices (e.g., computing platform 2104) determining whether the perceived SQS satisfies a predetermined target SQS. The method 2400 may then conclude at block 2412 with the one or more processing devices (e.g., computing platform 2104), in response to determining that the perceived SQS fails to satisfy the predetermined target SQS, performing one or more image treatments on the facial region of the user until the perceived SQS satisfies the predetermined target SQS.

Accordingly, as described by the method 2400 of FIG. 7, the present techniques are directed toward a subjective quality score (SQS) formula of the human visibility in additive display and artistic treatments are selected based on targeting SQS, which may be then injected, for example, into a volumetric video call or other AR-based videoconference to improve the visibility. For example, a method may include detecting the face region in an AR calling receiver side before the rendering. The method may further include calculating a median skin tone brightness by subsampling pixels in the face region. The method may further include calculating the receiver side display and background luminance. The method may further include deriving the perceived SQS from median facial tone brightness and display and/or background luminance. The method may further include evaluating the SQS gap between a target SQS and a perceived SQS. In response to determining that the target SQS is not satisfied, the method may further include determining the most optimal artistic treatments such that the target SQS may be satisfied. The method may then include injecting the selected artistic treatments (e.g., color correction, re-lighting, adding outline, sharpening, relighting, and so forth), into, for example, a volumetric video call or other AR-based videoconference rendering pipeline to improve the visibility. The method may then conclude with performing an SQS calculation on the rendered frame and feedback to adjust the artistic treatment intensity. In this way, users (e.g., on the sender side) with darker facial tones or complexions and/or when the AR device is used in an environment with brighter backgrounds (e.g., on the receiver side), the receiver side user may enable (or automatically enabled) inclusive rendering support to achieve enough visibility to perceive the sender user more clearly.

### Freeze Management in Video Conferencing

An embodiment of the invention is directed to a method that solves the problem of unflattering, unnatural, or unknown freezes to video feed during video conferencing. A component continuously monitors the video feed during a video conference. During proper live-feed intervals a system prepares a smooth transition frozen image, and during freeze intervals the system transitions to the prepared image (or images or video) on the one hand, and adds in a visual component to indicate to other individuals on the call that a freeze is in progress. This monitoring may be done by the server but is more likely done by each client, such that the system on each client device can monitor the feed coming from the other client devices and alert its own user of freeze events. The system is composed of the following parts: 1) Monitoring and feed control, 2) Synthetic feed, and 3) A synthetic feed freeze indicator.

For example, the quality of a video may be monitored by measuring the current bandwidth of the video feed. It also may be monitored using reference quality metrics which compare the quality of current frames or frame-rates to previous ones or no-reference quality metrics which focus on statistical features previously determined to be good measures of the current quality of a video frame. For any quality monitoring metric, a server system may monitor the client systems or the client systems may monitor the feed from the other client systems.

Monitoring and feed control: one embodiment uses the monitoring system to assess the feed on an ongoing basis and switches between the live-feed when it is available and of good quality and the synthetic freeze-feed when it is not. The minimum quality of feed to allow the live-feed is a configurable parameter (for instance, if under 1 fps, it could count as frozen). Another method of monitoring whether a freeze event has occurred is for the monitoring system to compare the current frame to previous frames to see if there are any changes, such as would be expected in proper live-feed.

Synthetic feed: one embodiment uses one or more options based on the synthesis from the live-feed in some previous timeframe (for example using a 1 minute window). One option is to use the best frame from the window (best-image option). For this option, a machine learning model can be used to score the quality of the still images. For this option, the program would be trained to figure out elements that make one image of an individual more flattering than another image of that same individual. Alternatively, the program could be trained to determine best quality based on factors such as clarity of the image or amount of time the image remains relatively still, thereby suggesting a more natural expression. Another option is to generate a composite image using many (or all) frames in the window (composite-image option). Such may be done by layering the images and blending them. A third option is to select a sequence with natural movement from the window of time (closed-loop natural behavior option). Determining whether a sequence contains natural movement may be done, for example, by monitoring the amount of movement within the window of time and choosing a sequence that either is relatively still or has been repeated within the window of time. Whichever method is used to create an image to be used when the feed for a particular client is frozen, a server may temporarily store this image and present it to client systems involved in the video conferencing, or each client system may temporarily store their own images to be presented to their users when another client's feed has frozen.

Synthetic feed freeze indicator: one embodiment places a filter on the synthetic image (or images or video) to indicate the freeze is happening. This filter can be a shattering-ice frame animation, or anything else that conveys this information (possibly configurable by the user). In addition, a clock that indicates how long the freeze has lasted may be used to help other people on the call understand how much was potentially missed. This superimposed image may be input by either the server or the individual client systems involved in the video conferencing.

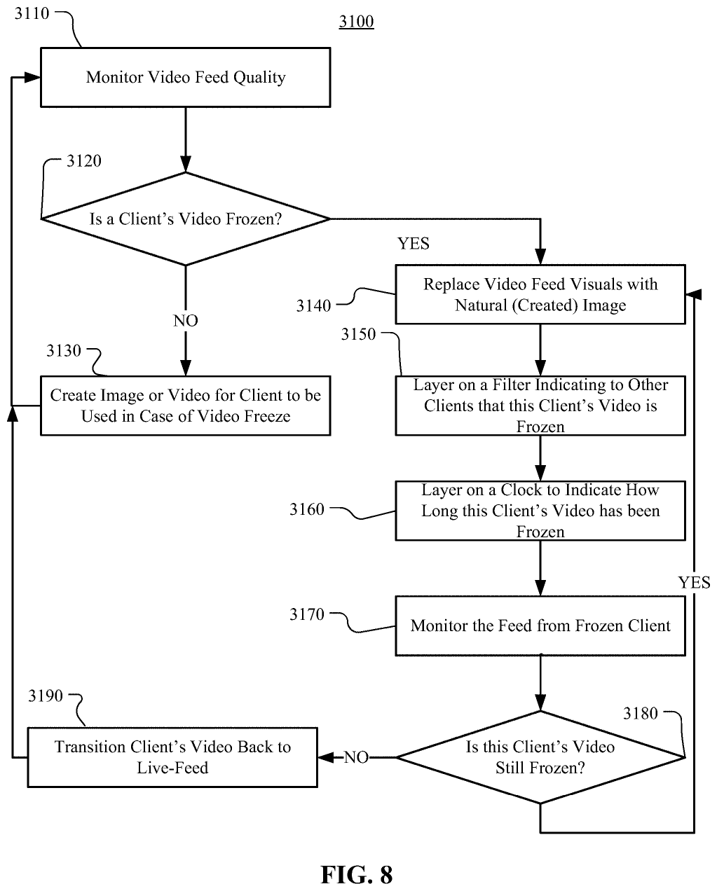

FIG. 8 illustrates an example method 3100 for the process of creating an image to be used in case of video freeze and layering another image on top of it in an instance where a freeze occurs. The method may begin at step 3110, where a system monitors the video feed of all participants on a video conference call. At step 3120, the system determines whether the video feed of a client system associated with any particular participant is frozen. If the answer is no, at step 3130, the system creates a video or image out of the previously monitored video feed in anticipation of a possible freeze event. If the answer is yes, at step 3140, the system replaces the effected client's video feed, as it is presented to the other client systems, with the previously created (in step 3130) video or image. Then, in step 3150, the system adds a filter, signifying that an individual's video has frozen, on a top of their image and, in step 3160, a timer to indicate how long that individual's video has been frozen. At step 3170, the system continues to monitor the frozen client's video feed. At step 3180, the system determines whether the video feed is still frozen. If the answer is yes, the system continues to run steps 3140 through 3180. If the answer is no, the system replaces the image with the live video feed, in step 3190, as it has determined that the freeze event is over. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for creating an image to be used in case of video freeze and layering another image on top of it in an instance where a freeze actually occurs including the particular steps of the method of FIG. 8, this disclosure contemplates any suitable method for creating an image to be used in case of video freeze and layering another image on top of it in an instance where a freeze actually occurs including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

### System Overview for Freeze Management

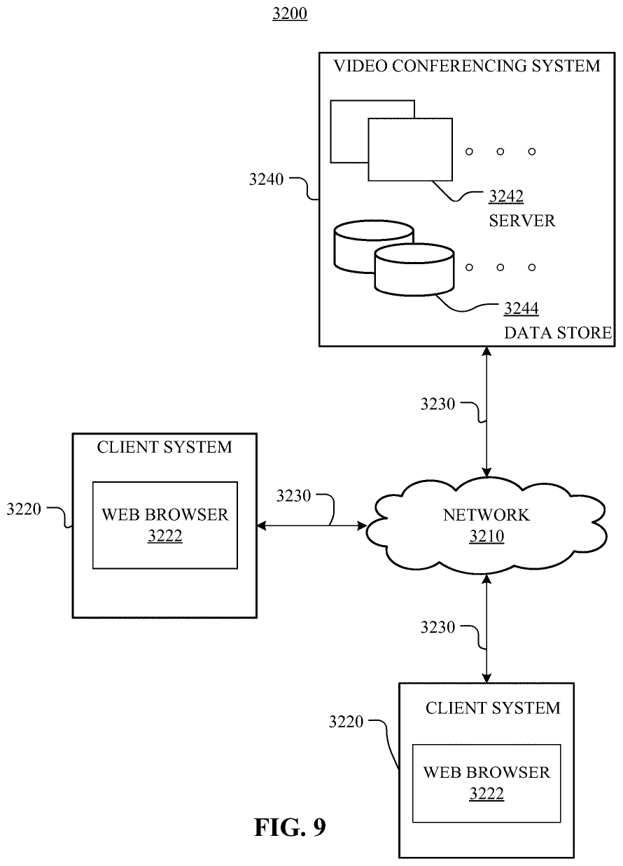

FIG. 9 illustrates an example network environment 3200 associated with a video conferencing system. Network environment 3200 includes a plurality of client systems 3220 and a video conferencing system 3240 connected to each other by a network 3210. Although FIG. 9 illustrates a particular arrangement of client systems 3220, video conferencing system 3240, and network 3210, this disclosure contemplates any suitable arrangement of client systems 3220, video conferencing system 3240, and network 3210. As an example and not by way of limitation, two or more of client systems 3230 and video conferencing system 3240 may be connected to each other directly, bypassing network 3210. As another example, two or more of client systems 3220 and video conferencing system 3240 may be physically or logically co-located with each other in whole or in part. Moreover, although FIG. 8 illustrates a particular number of client systems 3220, video conferencing system 3240, and network 3210, this disclosure contemplates any suitable number of client systems 3220, video conferencing systems 3240, and networks 3210. As an example and not by way of limitation, network environment 3200 may include multiple client systems 3220, video conferencing systems 3240, and networks 3210.

This disclosure contemplates any suitable network 3210. As an example and not by way of limitation, one or more portions of network 3210 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 3210 may include one or more networks 3210.

Links 3230 may connect client systems 3220 and video conferencing system 3240 to communication network 3210 or to each other. This disclosure contemplates any suitable links 3230. In particular embodiments, one or more links 3230 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 3230 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 3230, or a combination of two or more such links 3230. Links 3230 need not necessarily be the same throughout network environment 3200. One or more first links 3230 may differ in one or more respects from one or more second links 3230.

In particular embodiments, client system 3220 may be an electronic device including hardware, software, or embedded logic components or a combination of two or more such components and capable of carrying out the appropriate functionalities implemented or supported by client system 3220. As an example and not by way of limitation, a client system 3220 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 3220. A client system 3220 may enable a network user at client system 3220 to access network 3210. A client system 3220 may enable its user to communicate with other users at other client systems 3220.

In particular embodiments, client system 3220 may include a web browser 3222, and may have one or more add-ons, plug-ins, or other extensions. A user at client system 3220 may enter a Uniform Resource Locator (URL) or other address directing the web browser 3222 to a particular server (such as server 3242), and the web browser 3222 may generate a Hyper Text Transfer Protocol (HTTP) request and communicate the HTTP request to server. The server may accept the HTTP request and communicate to client system 3220 one or more Hyper Text Markup Language (HTML) files responsive to the HTTP request. Client system 3220 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, video conferencing system 3240 may be a network-addressable computing system that can host an online video conference. Video conferencing system 3240 may be accessed by the other components of network environment 3200 either directly or via network 3210. As an example and not by way of limitation, client system 3220 may access video conferencing system 3240 using a web browser 3222, or a native application associated with video conferencing system 3240 (e.g., a mobile video conferencing application, a messaging application, another suitable application, or any combination thereof) either directly or via network 3210. In particular embodiments, video conferencing system 3240 may include one or more servers 3242. Each server 3242 may be a unitary server or a distributed server spanning multiple computers or multiple datacenters. Servers 3242 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 3242 may include hardware, software, or embedded logic components or a combination of two or more such components for carrying out the appropriate functionalities implemented or supported by server 3242. In particular embodiments, video conferencing system 3240 may include one or more data stores 3244. Data stores 3244 may be used to store various types of information. In particular embodiments, the information stored in data stores 3244 may be organized according to specific data structures. In particular embodiments, each data store 3244 may be a relational, columnar, correlation, or other suitable database. Although this disclosure describes or illustrates particular types of databases, this disclosure contemplates any suitable types of databases. Particular embodiments may provide interfaces that enable a client system 3220 or a video conferencing system 3240 to manage, retrieve, modify, add, or delete, the information stored in data store 3244.

In particular embodiments, a video conferencing system 3240 may contain a server 3242 and data storage 3244. The server may be on the same device as one of the clients 3220. The clients could be individuals on a video call. In particular embodiments, the clients monitor the incoming video feed of the other individuals on the call, create the video or image from proper live-feed, replace the frozen feed with this created natural image, and continue to monitor so as to create the smooth transition back to live-feed when the freeze event is over. The video feed from the other clients 3220 may be routed through the server 3242.

In particular embodiments, the client systems 3220 may be remotely connected 3230 to the video conferencing system 3240 and to the other client systems 3220 through the network 3210. The client systems may contain a web browser 3222.

### Stretching Textures

Currently, there may be two ways that UV texture coordinates (UVs) get added to a surface's output mesh. The control cage UV coordinates can be interpolated as part of the tessellation stage or they can be created using baked triplanar projection. Typically triplanar texturing done by computing systems may use three texture reads in the pixel (fragment) shader, one for each axis and automatic UV mapping. The values from the three texture lookups may be blended for standard triplanar projection However, this process may be power intensive and these computing systems may not have any power constraints. For example, for a mobile computing system that is rendering textures, this process may be too power intensive to be effective. As such, another method of triplannar texturing is needed. Baked triplanar projection may only require a single texture lookup in the shader and no blending so it may be more efficient.

In particular embodiments, for user generated content, there may be primitives used that are defined by subdivision surfaces. That is, the primitives may be defined by simple meshes of quadrilaterals or triangles. A typical rendering pipeline may start with a step to access the mesh of the primitives. Then tessellation may then be performed on the mesh to generate triangles. After the triangles are generated, triplannar projection may be performed where UV coordinates are generated. Boolean computations may be performed after the triplannar projection. After Boolean computations are performed, batching may be done where the textures may be copied into vertex buffers for rendering.

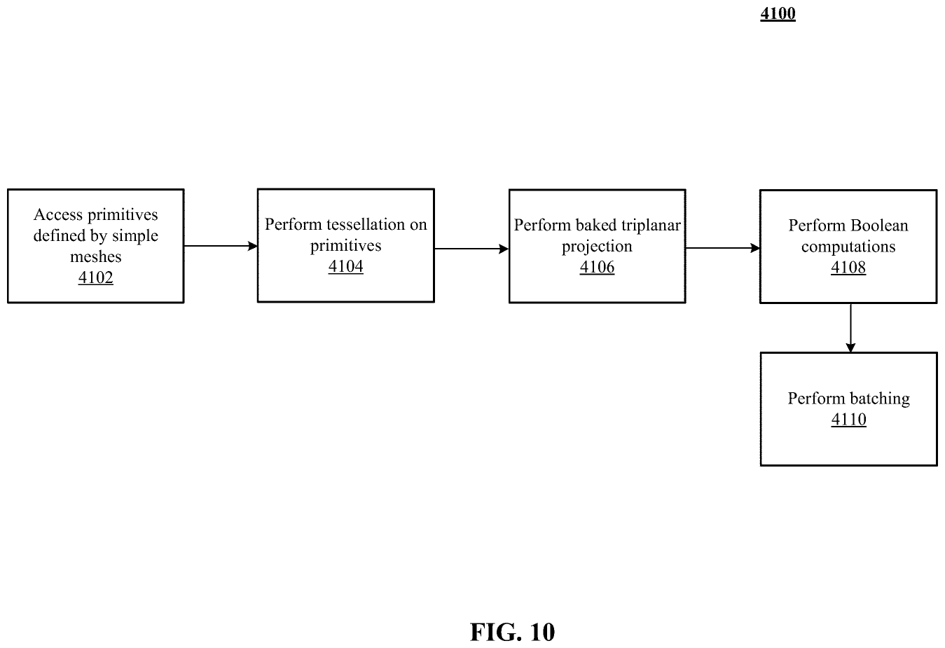

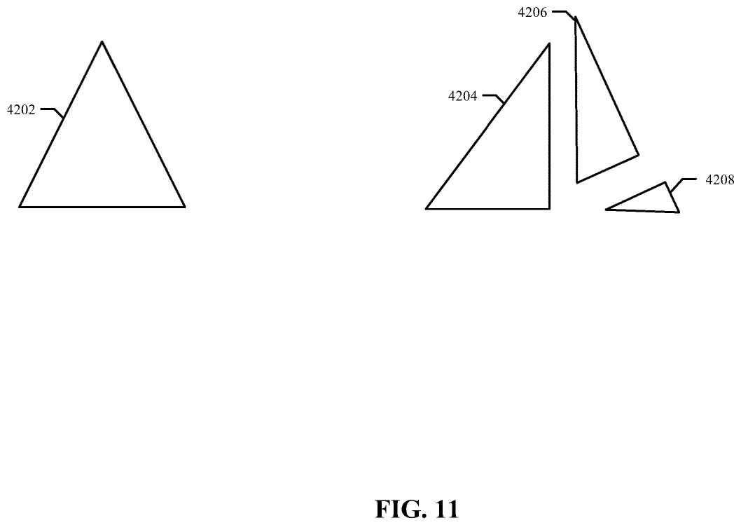

FIG. 10 illustrates an example process 4100 of baked triplanar projection. Triplanar projection is a way of turning 3D positional coordinates to 2D coordinates to look up into 2D textures. This enables application of a 2D texture to a 3D object automatically. Triplanar projection may pre-calculate the effects of rendering to generate bitmap images that are expressed in the 2D (UV) system of reference and coherently oriented with the mesh vertices In particular embodiments, the process 4100 may be performed by a computing system. In particular embodiments, the computing system may be embodied as one or more of an augmented reality, virtual reality, artificial reality, a smartphone, a laptop, a desktop, or another computing system. In particular embodiments, the process 4100 may start with step 4102, where a computing system may access primitives defined by simple meshes. As an example and not by way of limitation, for a virtual reality world building environment where a user can generate content (e.g., generate elements of the world), the user may add objects to the virtual reality world that each have their respective primitives. In step 4104, the computing system may perform tessellation on the primitives to generate triangles. The computing system may periodically perform tessellation based on certain conditions. Based on how certain objects are defined, there may be a distance where the computing system may need to perform tessellation again. As an example and not by way of limitation, a computing system may initially perform tessellation on an object that is 10 meters away. As the user approaches the object, crossing a threshold distance (e.g., 3 meters), then the computing system may perform tessellation on the object again. At step 4106, the computing system may perform baked triplanar projection on the triangles generated from the tessellation. In particular embodiments, baked triplanar projection may calculate the mesh's two UV coordinates by first transforming object space vertex positions as desired (e.g., translation, rotation, and scale) and then dropping one of the three coordinates to transform the 3D position into 2D. The decision of which coordinate to drop may be based on the component of vector normal to each triangle in the mesh with the largest absolute value, which selects the plane (e.g., x, y, or z) the triangle is facing the most. In particular embodiments, the mesh may be split in areas where triangles sharing a vertex do not agree on the projection plane. For rounded objects, the UV seam may appear jagged. However, for a smoother seam, the baked triplanar projection process may use a per-vertex normal instead of a per triangle normal. The triangles that have vertices that project to two different planes may be split into separate triangles as shown in FIG. 11. In particular embodiments, the sum of the normals of the three vertices may be used to select a plane if all three vertices project to different planes. At step 4108, the computing system may perform any Boolean computations. As an example and not by way of limitation, the Boolean computations may include a subtract, an intersect, and other kinds of Boolean computations. The computing system may not necessarily need to perform any Boolean computations. At step 4110, the computing system may perform batching where the computing system may copy the textures to apply to an object. The textures may be copied into vertex buffers for rendering. In particular embodiments, the computing system may also stamp a texture on a surface of a 3D object. The process 4100 may run asynchronously from a rendering process performed by the computing system.

FIG. 11 illustrates an example process of splitting triangles. An initial triangle 4202 that may be generated from tessellation as described herein may be split into three separate triangles 4204, 4206, and 4208 in response to determining that the vertices project to two different planes.

### System Overview

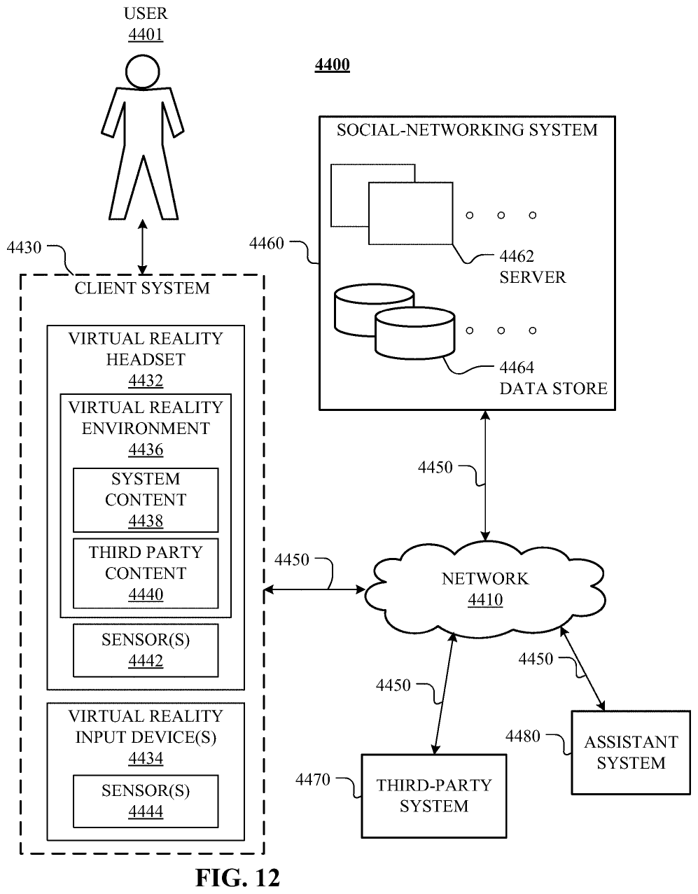

FIG. 12 illustrates an example network environment 4400 associated with an artificial reality system. Network environment 4400 includes a user 4401 interacting with a client system 4430, a social-networking system 4460, a third-party system 4470, and an assistant system 4480 connected to each other by a network 4410. Although FIG. 12 illustrates a particular arrangement of a user 4401, a client system 4430, a social-networking system 4460, a third-party system 4470, an assistant system 4480, and a network 4410, this disclosure contemplates any suitable arrangement of a user 4401, a client system 4430, a social-networking system 4460, a third-party system 4470, an assistant system 4480, and a network 4410. As an example and not by way of limitation, two or more of a user 4401, a client system 4430, a social-networking system 4460, a third-party system 4470, and an assistant system 4480 may be connected to each other directly, bypassing a network 4410. As another example, two or more of a client system 4430, a social-networking system 4460, a third-party system 4470, and an assistant system 4480 may be physically or logically co-located with each other in whole or in part. Moreover, although FIG. 12 illustrates a particular number of users 4401, client systems 4430, social-networking systems 4460, third-party systems 4470, assistant systems 4480, and networks 4410, this disclosure contemplates any suitable number of client systems 4430, social-networking systems 4460, third-party systems 4470, assistant systems 4480, and networks 4410. As an example and not by way of limitation, network environment 4400 may include multiple users 4401, client systems 4430, social-networking systems 4460, third-party systems 4470, assistant systems 4480, and networks 4410.

This disclosure contemplates any suitable network 4410. As an example and not by way of limitation, one or more portions of a network 4410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 4410 may include one or more networks 4410.

Links 4450 may connect a client system 4430, a social-networking system 4460, and a third-party system 4470 to a communication network 4410 or to each other. This disclosure contemplates any suitable links 4450. In particular embodiments, one or more links 4450 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 4450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 4450, or a combination of two or more such links 4450. Links 4450 need not necessarily be the same throughout a network environment 4400. One or more first links 4450 may differ in one or more respects from one or more second links 4450.

In particular embodiments, a client system 4430 may be an electronic device including hardware, software, or embedded logic components or a combination of two or more such components and capable of carrying out the appropriate functionalities implemented or supported by a client system 4430. As an example and not by way of limitation, a client system 4430 may include a computer system such as a desktop computer, notebook or laptop computer, netbook, a tablet computer, e-book reader, GPS device, camera, personal digital assistant (PDA), handheld electronic device, cellular telephone, smartphone, virtual reality headset and controllers, other suitable electronic device, or any suitable combination thereof. This disclosure contemplates any suitable client systems 4430. A client system 4430 may enable a network user at a client system 4430 to access a network 4410. A client system 4430 may enable its user to communicate with other users at other client systems 4430. A client system 4430 may generate a virtual reality environment for a user to interact with content.

In particular embodiments, a client system 4430 may include a virtual reality (or augmented reality) headset 4432 and virtual reality input device(s) 4434, such as a virtual reality controller. A user at a client system 4430 may wear the virtual reality headset 4432 and use the virtual reality input device(s) to interact with a virtual reality environment 4436 generated by the virtual reality headset 4432. Although not shown, a client system 4430 may also include a separate processing computer and/or any other component of a virtual reality system. A virtual reality headset 4432 may generate a virtual reality environment 4436, which may include system content 4438 (including but not limited to the operating system), such as software or firmware updates and also include third-party content 4440, such as content from applications or dynamically downloaded from the Internet (e.g., web page content). A virtual reality headset 4432 may include sensor(s) 4442, such as accelerometers, gyroscopes, magnetometers to generate sensor data that tracks the location of the headset device 4432. The headset 4432 may also include eye trackers for tracking the position of the user's eyes or their viewing directions. The client system may use data from the sensor(s) 4442 to determine velocity, orientation, and gravitation forces with respect to the headset. Virtual reality input device(s) 4434 may include sensor(s) 4444, such as accelerometers, gyroscopes, magnetometers, and touch sensors to generate sensor data that tracks the location of the input device 4434 and the positions of the user's fingers. The client system 4430 may make use of outside-in tracking, in which a tracking camera (not shown) is placed external to the virtual reality headset 4432 and within the line of sight of the virtual reality headset 4432. In outside-in tracking, the tracking camera may track the location of the virtual reality headset 4432 (e.g., by tracking one or more infrared LED markers on the virtual reality headset 4432). Alternatively or additionally, the client system 4430 may make use of inside-out tracking, in which a tracking camera (not shown) may be placed on or within the virtual reality headset 4432 itself. In inside-out tracking, the tracking camera may capture images around it in the real world and may use the changing perspectives of the real world to determine its own position in space.

Third-party content 4440 may include a web browser and may have one or more add-ons, plug-ins, or other extensions. A user at a client system 4430 may enter a Uniform Resource Locator (URL) or other address directing a web browser to a particular server (such as server 4462, or a server associated with a third-party system 4470), and the web browser may generate a Hyper Text Transfer Protocol (HTTP) request and communicate the HTTP request to server. The server may accept the HTTP request and communicate to a client system 4430 one or more Hyper Text Markup Language (HTML) files responsive to the HTTP request. The client system 4430 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, the social-networking system 4460 may be a network-addressable computing system that can host an online social network. The social-networking system 4460 may generate, store, receive, and send social-networking data, such as, for example, user-profile data, concept-profile data, social-graph information, or other suitable data related to the online social network. The social-networking system 4460 may be accessed by the other components of network environment 4400 either directly or via a network 4410. As an example and not by way of limitation, a client system 4430 may access the social-networking system 4460 using a web browser of a third-party content 4440, or a native application associated with the social-networking system 4460 (e.g., a mobile social-networking application, a messaging application, another suitable application, or any combination thereof) either directly or via a network 4410. In particular embodiments, the social-networking system 4460 may include one or more servers 4462. Each server 4462 may be a unitary server or a distributed server spanning multiple computers or multiple datacenters. Servers 4462 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 4462 may include hardware, software, or embedded logic components or a combination of two or more such components for carrying out the appropriate functionalities implemented or supported by server 4462. In particular embodiments, the social-networking system 4460 may include one or more data stores 4464. Data stores 4464 may be used to store various types of information. In particular embodiments, the information stored in data stores 4464 may be organized according to specific data structures. In particular embodiments, each data store 4464 may be a relational, columnar, correlation, or other suitable database. Although this disclosure describes or illustrates particular types of databases, this disclosure contemplates any suitable types of databases. Particular embodiments may provide interfaces that enable a client system 4430, a social-networking system 4460, or a third-party system 4470 to manage, retrieve, modify, add, or delete, the information stored in data store 4464.

In particular embodiments, the social-networking system 4460 may store one or more social graphs in one or more data stores 4464. In particular embodiments, a social graph may include multiple nodes—which may include multiple user nodes (each corresponding to a particular user) or multiple concept nodes (each corresponding to a particular concept)—and multiple edges connecting the nodes. The social-networking system 4460 may provide users of the online social network the ability to communicate and interact with other users. In particular embodiments, users may join the online social network via the social-networking system 4460 and then add connections (e.g., relationships) to a number of other users of the social-networking system 4460 whom they want to be connected to. Herein, the term “friend” may refer to any other user of the social-networking system 4460 with whom a user has formed a connection, association, or relationship via the social-networking system 4460.

In particular embodiments, the social-networking system 4460 may provide users with the ability to take actions on various types of items or objects, supported by the social-networking system 4460. As an example and not by way of limitation, the items and objects may include groups or social networks to which users of the social-networking system 4460 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 4460 or by an external system of a third-party system 4470, which is separate from the social-networking system 4460 and coupled to the social-networking system 4460 via a network 4410.

In particular embodiments, the social-networking system 4460 may be capable of linking a variety of entities. As an example and not by way of limitation, the social-networking system 4460 may enable users to interact with each other as well as receive content from third-party systems 4470 or other entities, or to allow users to interact with these entities through an application programming interfaces (API) or other communication channels.

In particular embodiments, a third-party system 4470 may include one or more types of servers, one or more data stores, one or more interfaces, including but not limited to APIs, one or more web services, one or more content sources, one or more networks, or any other suitable components, e.g., that servers may communicate with. A third-party system 4470 may be operated by a different entity from an entity operating the social-networking system 4460. In particular embodiments, however, the social-networking system 4460 and third-party systems 4470 may operate in conjunction with each other to provide social-networking services to users of the social-networking system 4460 or third-party systems 4470. In this sense, the social-networking system 4460 may provide a platform, or backbone, which other systems, such as third-party systems 4470, may use to provide social-networking services and functionality to users across the Internet.

In particular embodiments, a third-party system 4470 may include a third-party content object provider. A third-party content object provider may include one or more sources of content objects, which may be communicated to a client system 4430. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 4460 also includes user-generated content objects, which may enhance a user's interactions with the social-networking system 4460. User-generated content may include anything a user can add, upload, send, or “post” to the social-networking system 4460. As an example and not by way of limitation, a user communicates posts to the social-networking system 4460 from a client system 4430. Posts may include data such as status updates or other textual data, location information, photos, videos, links, music or other similar data or media. Content may also be added to the social-networking system 4460 by a third-party through a “communication channel,” such as a newsfeed or stream.

In particular embodiments, the social-networking system 4460 may include a variety of servers, sub-systems, programs, modules, logs, and data stores. In particular embodiments, the social-networking system 4460 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 4460 may also include suitable components such as network interfaces, security mechanisms, load balancers, failover servers, management-and-network-operations consoles, other suitable components, or any suitable combination thereof. In particular embodiments, the social-networking system 4460 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 4460 to one or more client systems 4430 or one or more third-party systems 4470 via a network 4410. The web server may include a mail server or other messaging functionality for receiving and routing messages between the social-networking system 4460 and one or more client systems 4430. An API-request server may allow a third-party system 4470 to access information from the social-networking system 4460 by calling one or more APIs. An action logger may be used to receive communications from a web server about a user's actions on or off the social-networking system 4460. In conjunction with the action log, a third-party-content-object log may be maintained of user exposures to third-party-content objects. A notification controller may provide information regarding content objects to a client system 4430. Information may be pushed to a client system 4430 as notifications, or information may be pulled from a client system 4430 responsive to a request received from a client system 4430. Authorization servers may be used to enforce one or more privacy settings of the users of the social-networking system 4460. A privacy setting of a user determines how particular information associated with a user can be shared. The authorization server may allow users to opt in to or opt out of having their actions logged by the social-networking system 4460 or shared with other systems (e.g., a third-party system 4470), such as, for example, by setting appropriate privacy settings. Third-party-content-object stores may be used to store content objects received from third parties, such as a third-party system 4470. Location stores may be used for storing location information received from client systems 4430 associated with users. Advertisement-pricing modules may combine social information, the current time, location information, or other suitable information to provide relevant advertisements, in the form of notifications, to a user.

In particular embodiments, the assistant system 4480 may assist users to retrieve information from different sources. The assistant system 4480 may also assist user to request services from different service providers. In particular embodiments, the assistant system 4480 may receive a user request for information or services the client system 4430. The assistant system 4480 may use natural-language understanding to analyze the user request based on user's profile and other relevant information. The result of the analysis may comprise different entities associated with an online social network. The assistant system 4480 may then retrieve information or request services associated with these entities. In particular embodiments, the assistant system 4480 may interact with the social-networking system 4460 and/or third-party system 4470 when retrieving information or requesting services for the user. In particular embodiments, the assistant system 4480 may generate a personalized communication content for the user using natural-language generating techniques. The personalized communication content may comprise, for example, the retrieved information or the status of the requested services. In particular embodiments, the assistant system 4480 may enable the user to interact with it regarding the information or services in a stateful and multi-turn conversation by using dialog-management techniques. In particular embodiments, the assistant system 4480 may help facilitate a virtual meeting between the client system 4430 and other client systems 4430. In particular embodiments, the assistant system 4480 may include a variety of servers, sub-systems, programs, modules, logs, and data stores.

### Systems and Methods

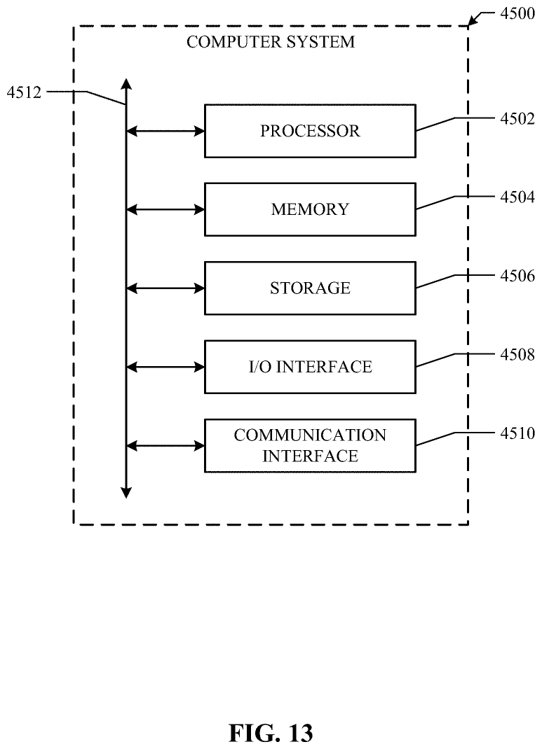

FIG. 13 illustrates an example computer system 4500. In particular embodiments, one or more computer systems 4500 perform one or more steps of one or more methods or processes described or illustrated herein. In particular embodiments, one or more computer systems 4500 provide functionality described or illustrated herein. In particular embodiments, software running on one or more computer systems 4500 performs one or more steps of one or more methods described or illustrated herein or provides functionality described or illustrated herein. Particular embodiments include one or more portions of one or more computer systems 4500. Herein, reference to a computer system may encompass a computing device, and vice versa, where appropriate. Moreover, reference to a computer system may encompass one or more computer systems, where appropriate.

This disclosure contemplates any suitable number of computer systems 4500. This disclosure contemplates computer system 4500 taking any suitable physical form. As example and not by way of limitation, computer system 4500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 4500 may include one or more computer systems 4500; be unitary or distributed; span multiple locations; span multiple machines; span multiple data centers; or reside in a cloud, which may include one or more cloud components in one or more networks. Where appropriate, one or more computer systems 4500 may perform without substantial spatial or temporal limitation one or more steps of one or more methods described or illustrated herein. As an example and not by way of limitation, one or more computer systems 4500 may perform in real time or in batch mode one or more steps of one or more methods described or illustrated herein. One or more computer systems 4500 may perform at different times or at different locations one or more steps of one or more methods described or illustrated herein, where appropriate.

In particular embodiments, computer system 4500 includes a processor 4502, memory 4504, storage 4506, an input/output (I/O) interface 4508, a communication interface 4510, and a bus 4512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 4502 includes hardware for executing instructions, such as those making up a computer program. As an example and not by way of limitation, to execute instructions, processor 4502 may retrieve (or fetch) the instructions from an internal register, an internal cache, memory 4504, or storage 4506; decode and execute them; and then write one or more results to an internal register, an internal cache, memory 4504, or storage 4506. In particular embodiments, processor 4502 may include one or more internal caches for data, instructions, or addresses. This disclosure contemplates processor 4502 including any suitable number of any suitable internal caches, where appropriate. As an example and not by way of limitation, processor 4502 may include one or more instruction caches, one or more data caches, and one or more translation lookaside buffers (TLBs). Instructions in the instruction caches may be copies of instructions in memory 4504 or storage 4506, and the instruction caches may speed up retrieval of those instructions by processor 4502. Data in the data caches may be copies of data in memory 4504 or storage 4506 for instructions executing at processor 4502 to operate on; the results of previous instructions executed at processor 4502 for access by subsequent instructions executing at processor 4502 or for writing to memory 4504 or storage 4506; or other suitable data. The data caches may speed up read or write operations by processor 4502. The TLBs may speed up virtual-address translation for processor 4502. In particular embodiments, processor 4502 may include one or more internal registers for data, instructions, or addresses. This disclosure contemplates processor 4502 including any suitable number of any suitable internal registers, where appropriate. Where appropriate, processor 4502 may include one or more arithmetic logic units (ALUs); be a multi-core processor; or include one or more processors 4502. Although this disclosure describes and illustrates a particular processor, this disclosure contemplates any suitable processor.

In particular embodiments, memory 4504 includes main memory for storing instructions for processor 4502 to execute or data for processor 4502 to operate on. As an example and not by way of limitation, computer system 4500 may load instructions from storage 4506 or another source (such as, for example, another computer system 4500) to memory 4504. Processor 4502 may then load the instructions from memory 4504 to an internal register or internal cache. To execute the instructions, processor 4502 may retrieve the instructions from the internal register or internal cache and decode them. During or after execution of the instructions, processor 4502 may write one or more results (which may be intermediate or final results) to the internal register or internal cache. Processor 4502 may then write one or more of those results to memory 4504. In particular embodiments, processor 4502 executes only instructions in one or more internal registers or internal caches or in memory 4504 (as opposed to storage 4506 or elsewhere) and operates only on data in one or more internal registers or internal caches or in memory 4504 (as opposed to storage 4506 or elsewhere). One or more memory buses (which may each include an address bus and a data bus) may couple processor 4502 to memory 4504. Bus 4512 may include one or more memory buses, as described below. In particular embodiments, one or more memory management units (MMUs) reside between processor 4502 and memory 4504 and facilitate accesses to memory 4504 requested by processor 4502. In particular embodiments, memory 4504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 4504 may include one or more memories 4504, where appropriate. Although this disclosure describes and illustrates particular memory, this disclosure contemplates any suitable memory.

In particular embodiments, storage 4506 includes mass storage for data or instructions. As an example and not by way of limitation, storage 4506 may include a hard disk drive (HDD), a floppy disk drive, flash memory, an optical disc, a magneto-optical disc, magnetic tape, or a Universal Serial Bus (USB) drive or a combination of two or more of these. Storage 4506 may include removable or non-removable (or fixed) media, where appropriate. Storage 4506 may be internal or external to computer system 4500, where appropriate. In particular embodiments, storage 4506 is non-volatile, solid-state memory. In particular embodiments, storage 4506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 4506 taking any suitable physical form. Storage 4506 may include one or more storage control units facilitating communication between processor 4502 and storage 4506, where appropriate. Where appropriate, storage 4506 may include one or more storages 4506. Although this disclosure describes and illustrates particular storage, this disclosure contemplates any suitable storage.

In particular embodiments, I/O interface 4508 includes hardware, software, or both, providing one or more interfaces for communication between computer system 4500 and one or more I/O devices. Computer system 4500 may include one or more of these I/O devices, where appropriate. One or more of these I/O devices may enable communication between a person and computer system 4500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 4508 for them. Where appropriate, I/O interface 4508 may include one or more device or software drivers enabling processor 4502 to drive one or more of these I/O devices. I/O interface 4508 may include one or more I/O interfaces 4508, where appropriate. Although this disclosure describes and illustrates a particular I/O interface, this disclosure contemplates any suitable I/O interface.

In particular embodiments, communication interface 4510 includes hardware, software, or both providing one or more interfaces for communication (such as, for example, packet-based communication) between computer system 4500 and one or more other computer systems 4500 or one or more networks. As an example and not by way of limitation, communication interface 4510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 4510 for it. As an example and not by way of limitation, computer system 4500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 4500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 4500 may include any suitable communication interface 4510 for any of these networks, where appropriate. Communication interface 4510 may include one or more communication interfaces 4510, where appropriate. Although this disclosure describes and illustrates a particular communication interface, this disclosure contemplates any suitable communication interface.

In particular embodiments, bus 4512 includes hardware, software, or both coupling components of computer system 4500 to each other. As an example and not by way of limitation, bus 4512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 4512 may include one or more buses 4512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing device:
identifying a feature in a first frame and a second frame of a video stream captured by a camera, the first frame being captured by the camera from a first viewpoint at a first time and the second frame being captured by the camera from a second viewpoint at a second time;
estimating a depth of the feature at the first time relative to the first viewpoint of the camera;
generating a reprojected position of the feature in the second frame by reprojecting a position of the feature at the first time into the second frame based on the depth of the feature at the first time, the first viewpoint of the camera at the first time, and the second viewpoint of the camera at the second time; and
generating a smoothed position of the feature at the second time in the second frame based upon a detected position of the feature at the second time in the second frame and the reprojected position of the feature in the second frame.

2. A method comprising, by a computing system:
displaying an artificial reality environment including at least a partial rendering of a user;
detecting a facial region of the user based on the partial rendering of the user;
determining a median facial tone brightness based on a sampling of pixels in the detected facial region;
determining a perceived subjective quality score (SQS) based on the median facial tone brightness and a background luminance;
determining whether the perceived SQS satisfies a predetermined target SQS; and
in response to determining that the perceived SQS fails to satisfy the predetermined target SQS, performing one or more image treatments on the facial region of the user until the perceived SQS satisfies the predetermined target SQS.

3. A computing system comprising:
one or more cameras capturing images or videos of environments;
a display;
one or more processors; and
a non-transitory memory coupled to the processors comprising instructions executable by the processors.

4. The computing system of claim 3, wherein the processors are operable when executing the instructions to:
receive a live video feed from another computing device;
monitor the live video feed;
prepare an image or video from the live video feed in response to a determination that a quality of the live video feed satisfies one or more predetermined criteria;
in response to a determination that a quality of the live video feed fails to satisfy the one or more predetermined criteria, replace the live video feed with the prepared image or video; and
place a notification indicating that the live video feed is frozen over the prepared image or video, wherein the notification indicating an amount of time that the live video feed has been frozen.

5. The computing system of claim 3, wherein the processors are operable when executing the instructions to:
access one or more primitives of a virtual reality environment;
perform tessellation on the one or more primitives to generate a plurality of triangles;
perform baked triplanar projection on the plurality of triangles to generate a 2D mesh comprising UV coordinates; and
perform batching on the 2D mesh to copy the 2D mesh into a vertex buffer for rendering.

6. The computing system of claim 3, wherein the processors are operable when executing the instructions to:
identify a feature in a first frame and a second frame of a video stream captured by a camera of the one or more cameras, the first frame being captured by the camera from a first viewpoint at a first time and the second frame being captured by the camera from a second viewpoint at a second time;
estimate a depth of the feature at the first time relative to the first viewpoint of the camera;
generate a reprojected position of the feature in the second frame by reprojecting a position of the feature at the first time into the second frame based on the depth of the feature at the first time, the first viewpoint of the camera at the first time, and the second viewpoint of the camera at the second time; and
generate a smoothed position of the feature at the second time in the second frame based upon a detected position of the feature at the second time in the second frame and the reprojected position of the feature in the second frame.

7. The computing system of claim 3, wherein the processors are operable when executing the instructions to:
display, using at least the display, an artificial reality environment including at least a partial rendering of a user;
detect a facial region of the user based on the partial rendering of the user;
determine a median facial tone brightness based on a sampling of pixels in the detected facial region;
determine a perceived subjective quality score (SQS) based on the median facial tone brightness and a background luminance;
determine whether the perceived SQS satisfies a predetermined target SQS; and
in response to determining that the perceived SQS fails to satisfy the predetermined target SQS, perform one or more image treatments on the facial region of the user until the perceived SQS satisfies the predetermined target SQS.
